(19) United States
(12) Patent Application Publication
(10) Pub. No.: US 2004/0163636 A1
(43) Pub. Date: Aug. 26, 2004

(54) Chickenwing grill

(76) Inventor: Albert Duke Norwood, Baton Rouge, LA (US)

Correspondence Address: Albert Duke Norwood, 3677 Ridgemont Dr., Baton Rouge, LA, 70814, US

(21) Appl. No.: 10/375,169

(22) Filed: Feb. 26, 2003

(51) Int. Cl. A47J 37/00

(52) U.S. Cl. 126/25 R; 99/448

(57) ABSTRACT

I've design a grill especially for cooking chickenwings. The grill has vertical spears that are design to cook chicken on both sides without turning over. To use it you must inpale chicken on vertical spears after you cut the wing in half. The grill can be use in the oven, microwave or bar-b-que grill.

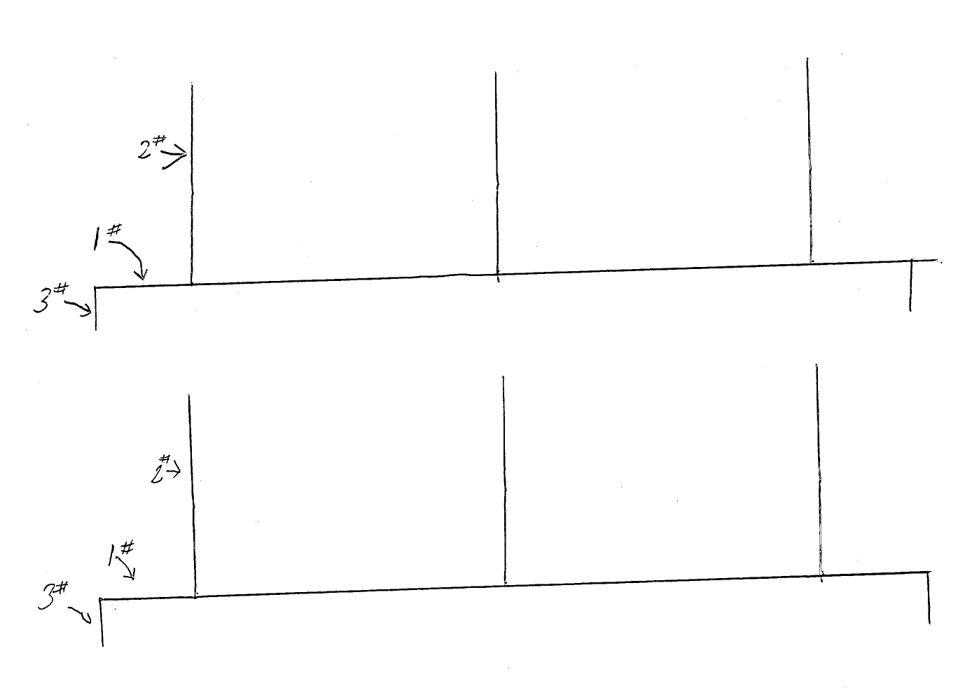

### BACKGROUND OF THE INVENTION

The chikenwing grill was invented to save time on food that was cook in the oven, microwave, or bar-b-que grill. The grill cooks food on both sides at one time so food can cook faster. That saves time on turning chicken over, and cooking one side longer than the other like in a oven. To use grill you must cut chickenwing in half at the joint remove wingtip and place each part on a spear.

### BRIEF SUMMARY OF THE INVENTION

The grill was design to cook chickenwigs on both sides which saves time when using the oven, microwave, or bar-b-que grill. The reason for cooking on both sides is to help the food cook faster and get a even tone on both sides. It also drains unwanted oils from chicken, which makes healther meal.

### DETAILED DESCRIPTION

#1 Are horizontal bars place in grill formation 3 inches apart.

#2 Are vertical spears placed on top of horizontal bars 3 by 3 inches apart, each spear is 2 inches in height

#3 Are half inch vertical legs placed at the bottom of horizontal bars at the end of each coner of the grill frame.

### Table of Contents

Desciptive title of the invention

Background of the invention

Brief summary of the invention . . . Page 1

Brief description drawing . . . Page 2

Detail description . . . Page 3

Description . . . Page 4

Claims . . . Page 5

Abstract . . . Page 6

### Descriptive title of the invention

The Chickenwing Grill: The chickenwing grill is design to cook nothing but chickenwing.

### Background of the Invention

The chickenwing grill was invent to save time on food that was cook in the oven, microwave, or bar-b-que grill. The grill cooks food both sides at one time so food can cook faster. That saves time on turning chicken over, and cooking one side longer than the other like in a oven. To use the grill you must cut chicken in half at the joint remove wingtip and place each part on a spear.

### Brief Summary of the Invention

The grill was design to cook chickenwing on both sides which saves time when using the oven, microwave, or bar-b-que grill. The reason for cooking on both sides is to help the food cook faster and get even tone on both sides. It also drains unwanted oils from chicken, which makes healther meal.

### Detailed Description of drawing

#1 Are bars placed in grill formation 3 inches apart.

#2 Are vertical spears placed on top of horizontal bars 3 by 3 inches apart, spear is 2 inches in height.

#3 Are half inch vertical legs placed at the bottom of horizontal bars at end of each coner of the grill frame.

### Description

The chickenwing grill has been design to cook nothing but chickenwings. There are horizontal bars placed in grill formaton. On top of the bars are vertical spears placed 3 by3 inches apart, each spear is 2 inches in height. At the bottom of the frame are half inch vertical legs placed at each coner of the frame.

1. What I claim as my invention are vertical spears which are 2 inches height and are 3 by 3 inches apart and that are attached to horizontal bars in grill formation. These spears are design to cook chickenwings faster in the oven, microwave or bar-b-que grill.
